(19) United States
(12) Patent Application Publication
(10) Pub. No.: US 2021/0149726 A1
(43) Pub. Date: May 20, 2021

(54) SCHEDULING DEVICE, SCHEDULING SYSTEM, SCHEDULING METHOD, AND NON-TRANSITORY COMPUTER-READABLE MEDIUM

(71) Applicant: Preferred Networks, Inc., Tokyo-to (JP)

(72) Inventors: Ryota ARAI, Tokyo-to (JP); Shingo OMURA, Tokyo-to (JP); Taisuke TANIWAKI, Tokyo-to (JP)

(73) Assignee: Preferred Networks, Inc., Tokyo-to (JP)

(21) Appl. No.: 17/159,904

(22) Filed: Jan. 27, 2021

Related U.S. Application Data
(63) Continuation of application No. PCT/JP2019/028690, filed on Jul. 22, 2019.

(30) Foreign Application Priority Data
Aug. 8, 2018 (JP) 2018-149726

(51) Int. Cl. G06F 9/48; G06N 20/00

(52) U.S. Cl. CPC G06F 9/4881; G06N 20/00; G06F 9/485; G06F 9/4818

(57) ABSTRACT

A scheduling device includes at least one storage and at least one processor. The at least one storage stores information regarding jobs in execution. The at least one processor is configured to accept a job, select, when an execution resource for the accepted job is not secured, at least one job with a lower priority than the accepted job from the jobs in execution as a stop candidate based on the information regarding the jobs in execution, and issue a stop instruction to the stop candidate.

### CROSS REFERENCE TO RELATED APPLICATIONS

This application is continuation application of International Application No. JP2019/028690, filed on Jul. 22, 2019, which claims priority to Japanese Patent Application No. 2018-149726, filed on Aug. 8, 2018, the entire contents of which incorporated herein by reference.

### FIELD

This disclosure relates to a scheduling device, a scheduling system, a scheduling method, and a non-transitory computer-readable medium.

### BACKGROUND

It is widely used in computers to execute multiple jobs simultaneously. Even for computers implemented as a cluster, it is often implemented in such a way that multiple jobs are started at the same timing on one or more computers in the cluster. A cluster is often implemented in such a way that multiple users can access it, and each of these multiple users can execute a job.

In such a case, when a user tries to execute a high-priority job under a state where sufficient resources are not available, other jobs will be suspended or stopped. The jobs to be suspended or the like are determined based on various indicators such as a priority assigned to each job. Many calculations performed using clusters are enormous, and one of the issues is how to extract the jobs to be suspended or the like from the jobs having a huge amount of calculations.

### BRIEF DESCRIPTION OF THE DRAWINGS

FIG. 1 is a diagram illustrating an example of a system where a scheduling device according to an embodiment is implemented;

FIG. 2 is a block diagram illustrating an example of the scheduling device according to an embodiment;

FIG. 3 is a block diagram illustrating an example of a job execution device according to an embodiment;

FIG. 4 is a conceptual diagram illustrating an example of a job in execution;

FIG. 5 a conceptual diagram illustrating an example of multiple jobs in execution;

FIG. 6 is a conceptual diagram illustrating an example where a high-priority job is enqueued;

FIG. 7 is a conceptual diagram illustrating another example where a high-priority job is enqueued;

FIG. 8 is a flowchart illustrating an example of processes of the scheduling device according to an embodiment;

FIG. 9 is a flowchart illustrating another example of the processes according to an embodiment;

FIG. 10 is a flowchart illustrating still another example of the processes according to an embodiment;

FIG. 11 is a flowchart illustrating an example of processes of the job execution device according to an embodiment; and

FIG. 12 is a block diagram illustrating an example of hardware implementation according to an embodiment.

### DETAILED DESCRIPTION

According to one embodiment, a scheduling device includes at least one storage and at least one processor. The at least one storage stores information regarding jobs in execution. The at least one processor is configured to accept a job, select, when an execution resource for the accepted job is not secured, at least one job with a lower priority than the accepted job from the jobs in execution as a stop candidate based on the information regarding the jobs in execution, and issue a stop instruction to the stop candidate.

Hereinafter, embodiments of the present invention will be explained with reference to the accompanying drawings. The explanations of the drawings and the embodiments are made as examples but not intended to limit the present invention.

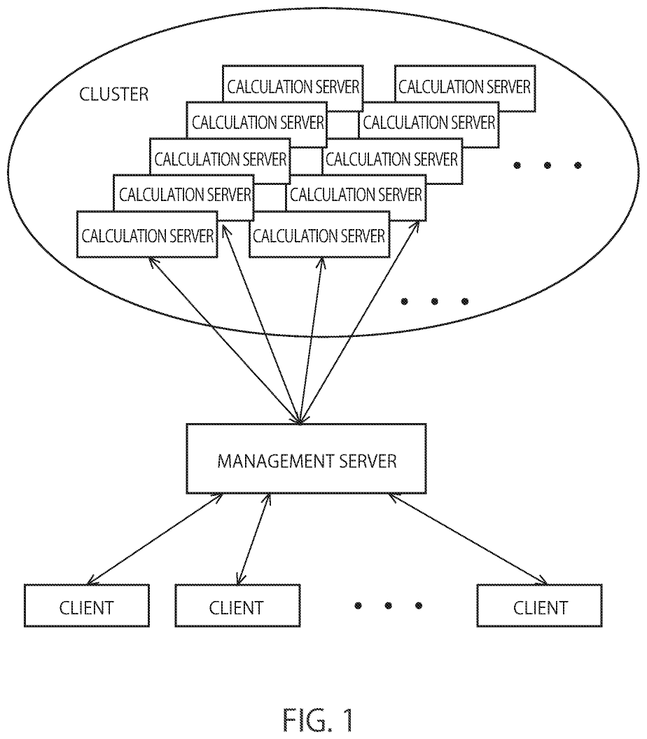

FIG. 1 is a diagram illustrating an example of a system using a scheduling device according to an embodiment. When a user registers or transmits a job from a client to a management server, the management server determines calculation resources used in the job and allocates the job (or more precisely, a task) to calculation servers. In this way, jobs are executed in the cluster by the management server based on the user's instructions. The user is not limited to a single user, and for example, multiple users can deploy jobs to the management server through multiple clients.

In FIG. 1, the cluster is formed by calculation servers, but it is not limited thereto. For example, it may be a granularity such as arithmetic cores installed in an accelerator or the like. The calculation server may be a cluster formed on a cloud or a cluster formed on-premise. The cluster may also be a set of arithmetic cores or the like. That is, although there are multiple servers in FIG. 1, scheduling in the following explanation can be applied to an allocation of jobs (or tasks) to arithmetic cores or the like, within a single server.

The transmission of jobs and the like from the client to the management server and from the management server to the calculation server may be done through a virtual machine environment. The deployment of arithmetic operations to the calculation server may be done using containers, for example. These techniques may be general and are not limited to any specific technology.

The scheduling device according to an embodiment is implemented, for example, in the management server. Although the management server is described as independent, it is not limited thereto, and at least one of the calculation servers configured as the cluster may have functions of the management server.

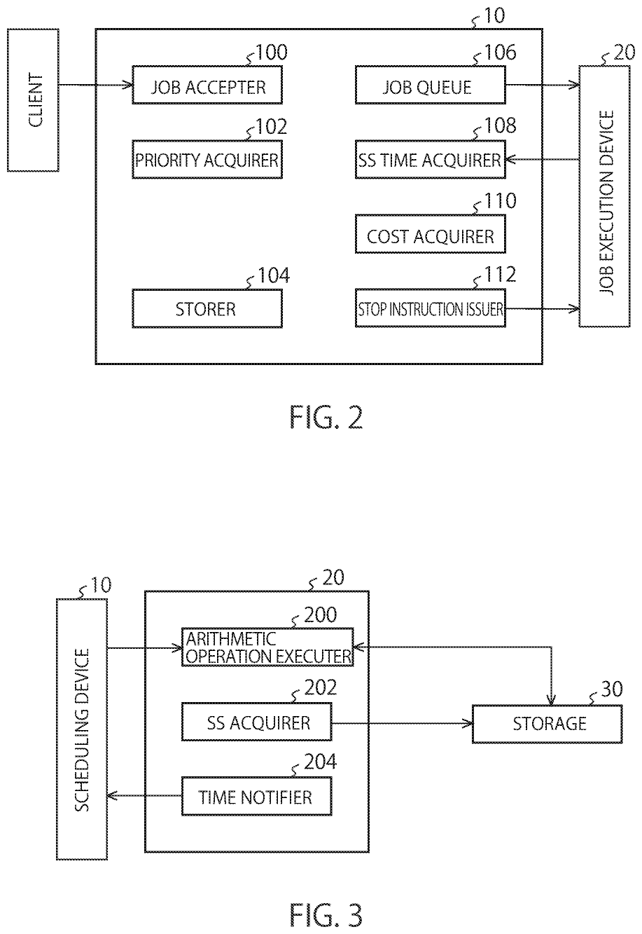

FIG. 2 is an example of a block diagram illustrating functions of the scheduling device according to an embodiment. A scheduling device 10 is, for example, a device that operates as a job scheduler, and includes a job accepter 100, a priority acquirer 102, a cost acquirer 110, a storer 104, a job queue 106, a stop instruction issuer 112, and an SS time acquirer 108. As an example, a client in FIG. 2 corresponds to the client in FIG. 1. Similarly, the scheduling device 10 and a job execution device 20 in FIG. 2 are implemented in the management server and the calculation server in FIG. 1, respectively, but the configuration need not be limited thereto.

The job accepter 100 accepts jobs based on instructions from the user. This instruction is transmitted, for example, through the client to the job accepter 100 of the scheduling device 10. The job accepter 100 may further function as a determination means to determine whether an accepted job is executable at the timing based on resources used for jobs enqueued in the job queue 106 and/or a job in execution in the job execution device 20.

The priority acquirer 102 acquires a priority of the job accepted by the job accepter 100. The acquired priority may be associated with the job and stored in the storer 104. The priority is a priority generally assigned to a job and is ranked, for example, as a high priority, medium priority, low priority, and the like. It is not limited thereto, but multiple priorities may further be represented with numerical values, or the priority may be two levels (for example, high and low). The priority may be set by the client or may be set by the user.

The storer 104 stores information necessary for operations of the scheduling device 10. For example, the storer 104 stores information regarding the jobs accepted by the job accepter 100, information regarding the jobs already in operation, information necessary for calculating a cost of the job in operation, information regarding the time at which a snapshot transmitted by each job is acquired, and so on. In addition to the above, when the scheduling device 10 is operated by software, the storer 104 may also store programs necessary to operate the software, binary files, or the like.

The job queue 106 is a queue that enqueues the jobs accepted by the job accepter 100. This job queue 106 may be formed by a normal queue or a priority queue. When the queue is not the priority queue, an instruction may be preferentially transmitted to the job execution device 20 that executes the job without going through the job queue 106 when a high-priority job is accepted. When the queue is the priority queue, for example, the high priority job may be moved to near the top of the queue. The priority queue may be implemented in a heap, for example, or in any other implementation. For dequeuing, the scheduling device 10 may transmit the job at the top of the queue to the job execution device 20 at a timing when the job execution device 20 has sufficient free resources, or the job execution device 20 may acquire the job at the top of the queue.

The SS time acquirer 108 acquires the time at which the job execution device 20 acquired a snapshot (SS) from the job execution device 20. For example, the job execution device 20 stores the time at the timing when it starts to acquire the snapshot and transmits the stored time to the SS time acquirer 108 after the snapshot has been acquired. The SS time acquirer 108 receives and acquires the time. The acquired time may be stored in the storer 104 in association with the job or stored by the SS time acquirer 108. By acquiring the snapshot (or information dumping its state) at an appropriate timing in one job, a suspended job can be restarted by referring to the snapshot. The snapshot acquired by each job is stored in a shared storage, or the like.

That is, the snapshot is acquired and stored as resume information, which is information that enables each job to be resumed to a state where the snapshot is acquired. The time when the acquisition of the snapshot is started is the time when each job acquires the resume information. In this way, the SS time acquirer 108 acquires the time at which each job in operation acquired the resume information and stores it in the storer 104. In the following, the snapshot is used for explanation, but other resume information can be substituted, for example, a data set or the like required for resuming, which is dumped at appropriate timing.

When a high-priority job is accepted by the job accepter 100 in a state where jobs are enqueued in the job queue 106, the cost acquirer 110 acquires a cost of each job that is in operation at that timing. The cost acquirer 110 may further function as a selection means to select a job to be stopped (hereinafter referred to simply as a stop candidate) based on the acquired cost. The acquisition of the cost is determined based on the time when the snapshot of each job is acquired, which is stored in the storer 104. It may also be dependent on information used for cost calculation of each job.

The information used for the cost calculation is, for example, the number of arithmetic cores used by a job, memory usage, hard disk usage, a communication bandwidth, a heat quantity generated when performing arithmetic operations, power consumption, or information represented by an amount of money or a ratio to a predetermined reference value so that this information can be understood in a unified manner. The information is an index per unit time. The cost acquirer 110 may, for example, use an elapsed time from the time when the snapshot is acquired to the current time as the cost, or use a value obtained by multiplying this elapsed time by the above-mentioned index per unit time as the cost or even use a function, which calculates the cost by using other parameters such as the priority to calculate the cost.

The stop instruction issuer 112 issues an instruction to stop the operation of a low-cost job regarding the cost of each job acquired by the cost acquirer 110, and transmits the instruction to the job execution device 20. The job execution device 20 stops the operation of the low-cost job based on the stop instruction. After stopping, the job execution device 20 may transmit to the scheduling device 10 that resources used by the job have become available resources.

In FIG. 2, the job queue 106 is provided in the scheduling device 10, but it is not limited thereto. For example, the job queue 106 may be provided separately from the scheduling device 10, and the scheduling device 10 may be configured to enqueue accepted jobs and stopped jobs (jobs to be restarted when resources are secured) to the job queue 106.

FIG. 3 is an example of a block diagram illustrating functions of the job execution device 20 according to an embodiment. The job execution device 20 includes an arithmetic operation executer 200, an SS acquirer 202, and a time notifier 204. The job execution device 20 may be virtually implemented on a processing circuit or may be a container that does not have a concrete hardware configuration (in more detail, the configuration is not necessary to be concretely considered).

The arithmetic operation executer 200 executes arithmetic operations to be executed in a job. The execution of the arithmetic operations may be performed using a processing circuit, such as an arithmetic core implemented on an accelerator, for example. When a job is transmitted from the job queue 106 to the job execution device 20 or the job execution device 20 is generated, the arithmetic operation executer 200 checks whether resume information for the job, that is, a snapshot has been recorded in the storage 30.

If there is no snapshot for the job, the job is executed after initialization. If there is a snapshot for the job, the snapshot is used to restart the stopped or suspended job.

While performing the arithmetic processing in a job, the SS acquirer 202 acquires a snapshot as the resume information at a predetermined timing and stores it in the storage 30. The snapshot is acquired by recording, for example, parameters required for the arithmetic operation, parameters that have been optimized by previous arithmetic operations, a seed of random numbers and a position or the like in a random number table at the time of acquiring the snapshot, and other parameters required for the arithmetic operations or parameters that may be obtained as a progress of the arithmetic operations. Thus, the snapshot may be a snapshot of an entire job being processed or may be a concept that includes a set of information that dumps data necessary to resume the state, data by data.

As described above, when a job is executed by the arithmetic operation executer 200, it is necessary to determine whether the job is to perform a new arithmetic operation or to restart from a stopped or suspended state. For this reason, the SS acquirer 202 may store the snapshot in the storage 30 with information indicating the job to which the snapshot belongs, such as an identifier of the job.

Alternatively, a table or the like may be provided in the storage 30, and the table or the like may store information regarding the job that stored the snapshot. The information regarding the job may be, for example, an ID uniquely assigned to the job, or information obtained from the job such as a hash value.

The SS acquirer 202 further acquires the time at which the acquisition of the snapshot is started. After completing the acquisition of the snapshot, the time notifier 204 transmits the start time acquired by the SS acquirer 202 to the scheduling device 10.

When the arithmetic operation of the job is performed in parallel on multiple nodes, the snapshot may be acquired at each node. This is not limited thereto, and information of each node may be aggregated to a master node to acquire the snapshot. When the snapshot is acquired at each node, for example, the time is stored based on the snapshot, which is acquired the last, but this is not limited thereto.

When there is already a snapshot of the same job in the storage 30, the SS acquirer 202 may erase (delete) the past snapshot at the timing when the snapshot is acquired. Alternatively, a predetermined number of snapshots may be left, and when there are more than the predetermined number of snapshots at the timing, the oldest snapshot may be erased. This predetermined number may be set by each job.

The storage 30 is a storage area for storing the snapshots. The storage 30 may be the shared storage that is provided outside the job execution device 20 and is accessible by multiple job execution devices 20. The storage 30 may be file storage or object storage.

By making the storage 30 accessible from multiple job execution devices 20, it is possible to check whether a snapshot has been acquired for a stopped or suspended job even when a new job execution device 20 is virtually generated. Furthermore, when the snapshot has been acquired, it is possible to refer to the latest snapshot acquired at the timing when the job to be executed on the new job execution device 20 is stopped or suspended in the past.

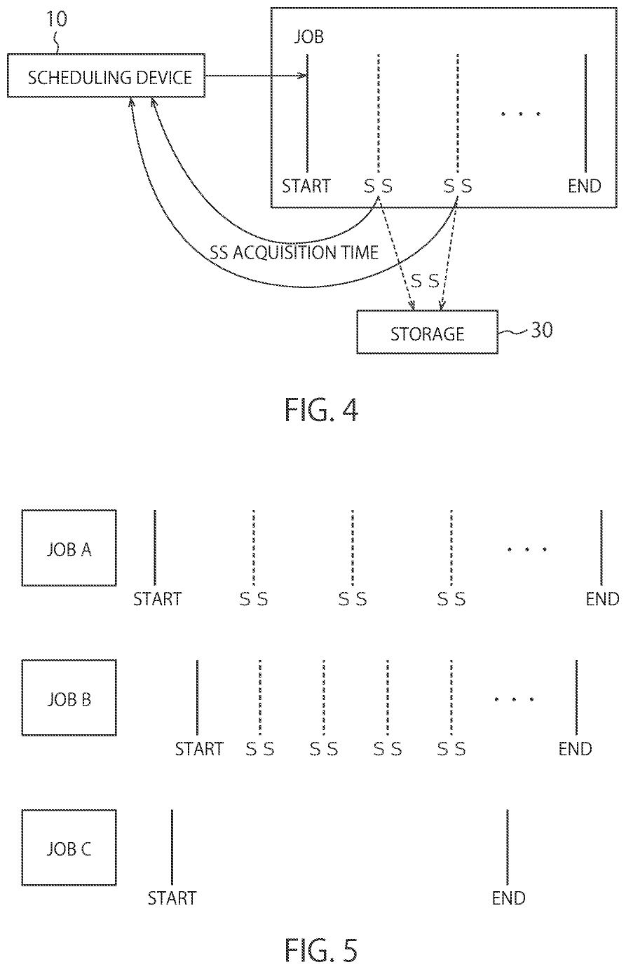

Hereinafter, a state of the scheduling of the scheduling device 10 described above will be explained by using a conceptual diagram. FIG. 4 is the conceptual diagram illustrating a state of a job in execution.

First, the scheduling device 10 instructs the execution of a job. This instruction is given by enqueuing the job to the job queue and dequeuing the job from the job queue, as described above.

When a job is started in the job execution device 20, the job acquires a snapshot at a predetermined timing. As illustrated by the dashed arrows in the diagram, the acquired snapshot is stored in the storage 30. On the other hand, at the timing when the snapshot is acquired by the job execution device 20 or when the snapshot is stored in the storage 30, the time when the snapshot acquisition is started is transmitted to the scheduling device 10.

In this way, when there is no interruption of a high-priority job in a situation where arithmetic resources are insufficient, a snapshot is acquired at a predetermined timing, stored in the storage 30, and the arithmetic operation is repeated until the job ends. The predetermined timing does not mean that an interval at which the snapshot is acquired is equal, but can be changed according to the job, for example, every predetermined iteration in optimization calculation, every predetermined number of data in big data processing, a degree of decrease in an evaluation function, or every epoch in machine learning, and the like. Certainly, it is also possible to acquire the snapshots at predetermined intervals, but even in this case, the intervals do not have to be exactly the same.

FIG. 5 is a diagram illustrating an example of a state of a job when there are multiple jobs. In this diagram, the start and end represent the timing of the start and end of a job, respectively, and the dashed line marked SS represents the timing of acquiring a snapshot.

Job A acquires a snapshot at a predetermined cycle after it starts, and then the job ends. Job B acquires a snapshot in a predetermined cycle after it starts, but in a shorter cycle than Job A in terms of time, and the job ends. The end time of the job is before that of Job A. Job C ends without acquiring a snapshot after it starts.

It is explained how to operate when Job X with high priority is enqueued to the job queue 106 in a state where resources are insufficient. However, it is assumed that Job X is a job for which the resources to be used can be secured by stopping Job A, B, or C. The following explanation assumes that the job queue 106 is the priority queue. When the queue is not the priority queue, the same effect as described below can be obtained by temporarily stopping the dequeue from the queue and transmitting Job X directly to an arithmetic unit for execution without enqueuing it to the job queue 106.

When it is determined that there are not enough resources at the timing of enqueuing Job X to the job queue 106, the priority acquirer 102 acquires a priority of Job X. When the priority of Job X is not higher than the priority of Job A, B, or C, Job X is enqueued to the job queue 106.

On the other hand, when the priority of Job X is higher than any of Jobs A, B, and C, Job X is enqueued to the job queue 106, and then one of Jobs A, B, and C is stopped. When there is a job with a lower priority in Jobs A, B, and C, the job is stopped and Job X is executed. For example, when Job A has a lower priority than Jobs B and C, Job X enqueued in the job queue 106 is executed by stopping Job A.

When the priorities of Jobs A, B, and C are not superior or inferior, costs of Jobs A, B, and C are acquired, and the job with a low cost is stopped.

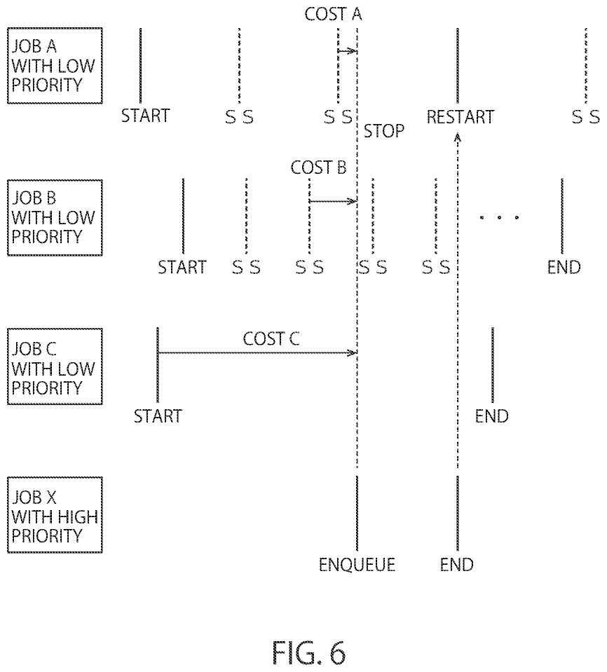

FIG. 6 illustrates a conceptual diagram of the case where an elapsed time from the time when the snapshot is most recently acquired in each job is acquired as a cost. The cost acquirer 110 calculates time from the time when the snapshot for each job stored in the storer 104 is acquired by the SS time acquirer 108 to the timing when Job X is accepted by the job accepter 100 or when Job X is enqueued to the job queue 106 as the elapsed time, and the calculated elapsed time is acquired as the cost.

For example, when Job X is accepted or enqueued at the timing illustrated in the diagram, each cost is illustrated by a solid arrow. In this case, a comparison is made by a length of the arrow as the size of the cost, and cost A<cost B<cost C. When no snapshot has been acquired, for example, in the case of Job C, the time from the start time of the job is acquired.

When Cost A is the minimum as illustrated in the diagram, Job A is stopped and Job X is executed. Stopping the job is executed by the stop instruction issuer 112 issuing an instruction to stop the job to Job A based on the cost acquired by the cost acquirer 110. When Job A is stopped, the execution of Job X enqueued in the priority queue is started.

The stopped Job A may be enqueued to become the top of the job queue 106, for example. In this way, as illustrated in FIG. 6, after the execution of Job X ends, Job A is dequeued from the job queue 106 and the execution of Job A is started. Job A, which has started execution, refers to the snapshot stored in the storage 30 and restarts the job from a stopped position. When Job A is re-enqueued, it does not necessarily have to be at the top of the job queue 106 but may be enqueued to be executed after a job with a higher or equal priority than Job A, when such a job exists in the job queue. Another implementation may simply enqueue Job A to the end of the job queue.

When Job C ends before Job X, Job A may restart the job using resources that have been used by Job C, if there are enough resources for Job A to use. In this way, it is not necessary to restart the job using the same resources that have been used before the stop. By making the storage 30 the shared storage that is accessible from each resource, it is possible to restart jobs smoothly.

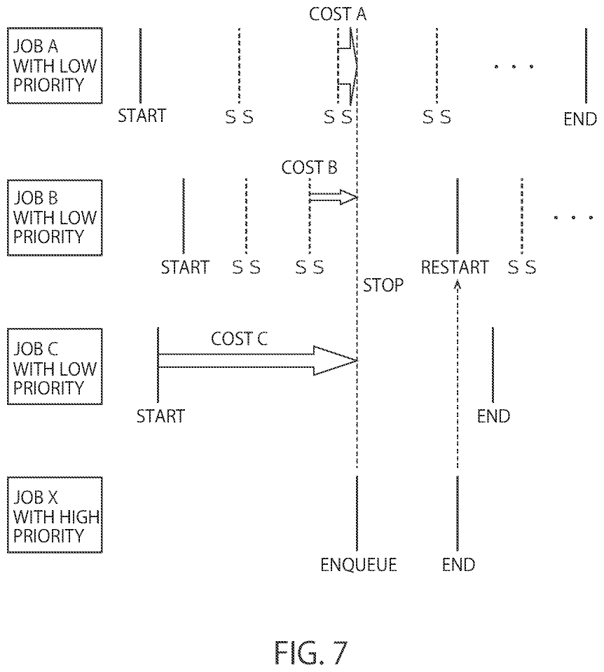

FIG. 7 is a schematic diagram illustrating a state of job execution in the case of another example of cost acquisition. Even if Job X is enqueued at the same timing as in FIG. 6, Job A is not necessarily stopped depending on the method of cost acquisition.

For example, in FIG. 7, suppose that the cost is calculated as a resource usage rate per unit time (cost per unit time)×time since the last snapshot acquisition. When a value obtained by multiplying the cost per unit time of Job A by time is larger than a value obtained by multiplying the cost per unit time of Job B by time, and the cost of Job C is larger than that of Job A, then Cost B<Cost A<Cost C.

In this case, Job B is stopped and the execution of Job X is started. Then, Job B is enqueued to the top of the job queue 106. In this way, it is possible to preferentially execute Job X and to restart the stopped Job B as soon as resources are available.

The cost per unit time may be calculated from, for example, costs relating to the use of processing circuits or storage areas, such as a GPU (Graphical Processing Unit), CPU (Central Processing Unit), memory, HDD (Hard Disc Drive), and an FPGA (Field Programmable Gate Array), or from costs including communication costs such as communication buses, and Infini Band. Certainly, as mentioned above, the heat generated, power consumption, and the like may also be used as the cost, or a combination of these examples may be calculated as the cost per time. By digitizing the cost per unit time in a unified manner, the cost can be acquired simply.

In the examples of FIG. 6 and FIG. 7, Job X is assumed to have sufficient resources by stopping Jobs A, B, or C. However, this is not limited thereto. For example, when resources are not sufficient to stop only one job, multiple jobs may be stopped. Candidates for stop may be selected in order of cost, starting with the lowest cost job, and jobs may be stopped up to a point where resources can be secured to execute a high-priority job. Another approach may be to consider the resources being used at the time of acquiring the cost.

The priority is assumed to be high and low, but there may be three or more priorities. In this case, a low-priority job may be selected as a stop candidate regardless of its cost, and within the same priority, the stop candidate may be selected by calculating the cost as described above.

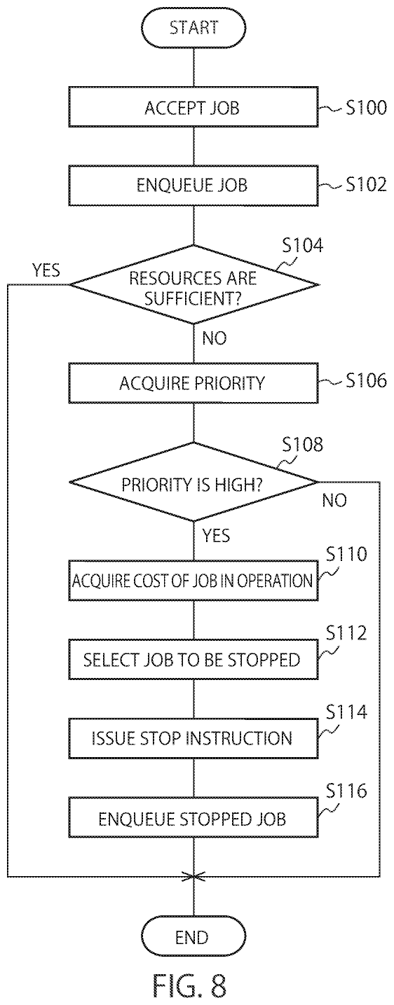

FIG. 8 is a flowchart illustrating processes for the scheduling described above. This flowchart is used to explain the flow of the processes for scheduling.

First, the job accepter 100 of the scheduling device 10 accepts a job (S100).

Next, the job accepted by the job accepter 100 is enqueued to the job queue 106 (S102). When the job queue 106 is a priority queue, the job is enqueued according to the priority of the accepted job. When the priority is checked at the time of enqueuing, S106 described below may be omitted.

Next, it is judged whether there are sufficient resources to execute the accepted job (S104). Whether the resources are sufficient may be determined by monitoring with a resource monitor or the like. When a job already exists in the job queue 106, it may be determined that there are not enough resources.

When the resources are sufficient (S104: YES), the scheduling device 10 causes the jobs enqueued in the job queue 106 to be executed in order and shifts to a state of accepting jobs. When there are not sufficient resources (S104: NO), the priority acquirer 102 acquires a priority of the accepted job (S106).

Next, the priority of the job in execution and the priority of the accepted job are compared (S108). When the priority of the accepted job is lower than the priority of the job being executed, or when the priorities are the same (S108: NO), the scheduling device 10 causes the jobs enqueued in the job queue 106 to be executed in order and shifts to the state of accepting jobs.

When the priority of the accepted job is higher than the priority of the job being executed (S108: YES), the cost acquirer 110 acquires the costs of the jobs in operation (S110). When only one job with a low priority is being executed, the process of S114 may be performed without performing the following selection process.

Next, jobs to be stopped (stop candidates) are selected based on the costs acquired by the cost acquirer 110 (S112). The stop candidates are selected in order of decreasing cost for one or more jobs until the resources for the high priority job that is enqueued and is about to be executed can be secured.

Next, the stop instruction issuer 112 transmits the stop instruction of the job to the stop candidate (S114). The SS acquirer 202 acquires a snapshot of the job for which the stop instruction has been issued, as the resume information and stores it in the appropriate storage 30. When the snapshot is acquired, the information of the time when the acquisition of the snapshot is started is transmitted to the SS time acquirer 108. The SS time acquirer 108 stores the acquired time in the storer 104 at an appropriate timing after S114, such as the timing when the SS time is acquired or the timing when the stopped job is re-enqueued, for example.

Then, the stop candidate is enqueued to the job queue 106 (S116). It may be enqueued after verifying that it has been stopped, or it may be enqueued so that it is executed later than a high-priority job at the timing of issuing the stop instruction.

Although not illustrated in FIG. 8, when the acquisition time of the snapshot (resume information) is transmitted from the job execution device 20, the SS time acquirer 108 stores the acquisition time in the storer 104 at the timing when the acquisition time is received. In this case, when the acquisition time is a future time, an update of the time may be rejected.

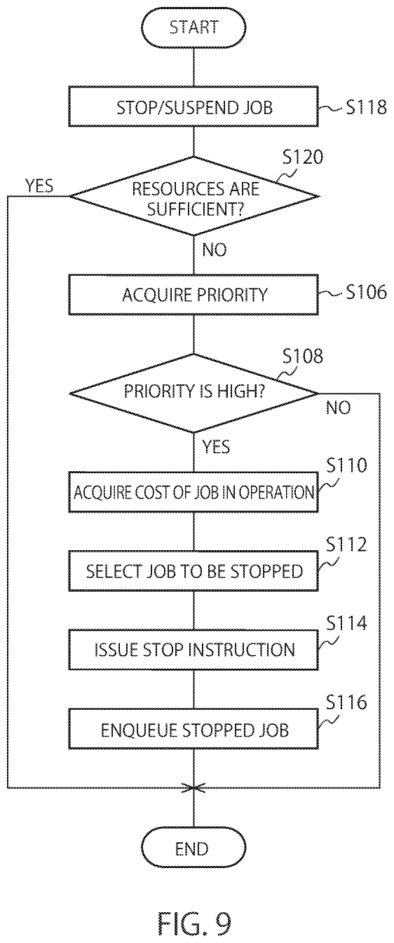

FIG. 9 is a flowchart illustrating processes for a modification example of this embodiment. While FIG. 8 illustrates the processes when a new job is accepted, FIG. 9 illustrates the processes when a job that is already in operation is stopped or suspended.

First, a job is stopped or suspended for some reason (S118). The job may be stopped or suspended by the user's instruction at any timing, or it may be stopped or suspended as error processing when a situation occurs in a calculation server or management server that makes it impossible to execute.

In such a case, it is judged whether there are sufficient resources to execute the job at the top of the enqueued jobs in the job queue 106 or the job that is enqueued at an earlier timing from among the jobs with the highest priority existing in the job queue 106 (S120). The subsequent processes are the same as those illustrated in FIG. 8. In this way, the scheduling device 10 may operate not only when a job is accepted but also when a job is stopped/suspended as a flag.

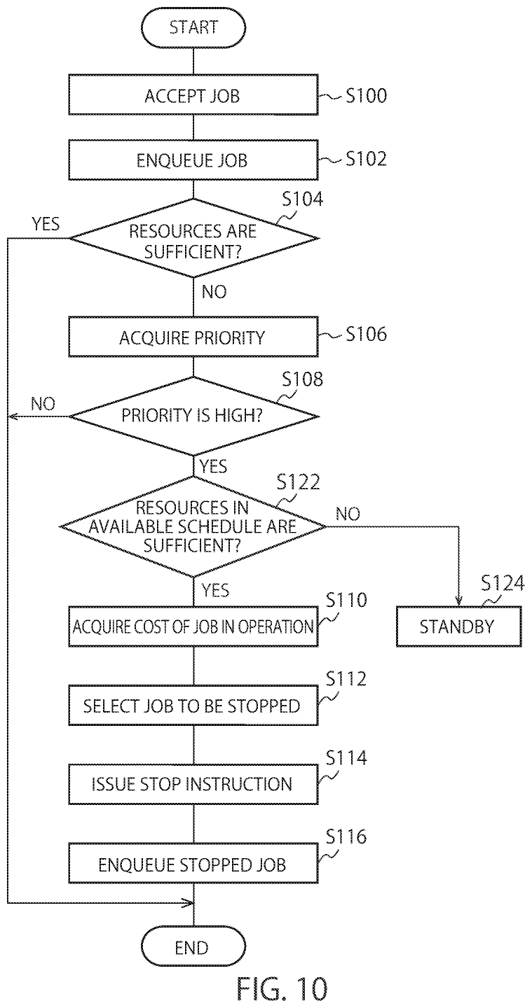

FIG. 10 is a flowchart illustrating processes for another modification example of this embodiment. The processes up to the judgment of the priority (S108) are the same as the processes illustrated in FIG. 8. After judging the priority, when the sum of resources used by a low-priority job at that timing is small compared to the resources required by the accepted job, there are few resources to be released even if the low-priority job is suspended, and the accepted job cannot be operated.

Then, it is determined whether an available schedule, that is, the sum of resources used by jobs with a lower priority than the accepted job, is larger than (whether the sum is equal to or larger than) the resources used by the accepted job (S122). When the resources to execute the accepted job (execution resources) can be secured (S122: YES), the processes from S110 are executed.

On the other hand, when it is difficult to secure the resources to execute the accepted job (S122: NO), the process moves to a standby process (S124). This standby process is, for example, a process to wait until the resources can be secured. The job may be executed at the timing when the resources can be secured. As another example, when a job with the same priority as the accepted job is newly accepted, and when the newly accepted job uses fewer resources than the accepted job, the newly accepted job may be executed.

When the resources to be released are fewer than the resources required for execution, the accepted job cannot be executed even if the low-priority job is stopped, so the low-priority job is continued to be executed. In this way, it is also possible to improve the resource usage rate of the system as a whole by ensuring that no resources are left vacant. Note that S122 and S124 in FIG. 9 can also be applied to the case of FIG. 8.

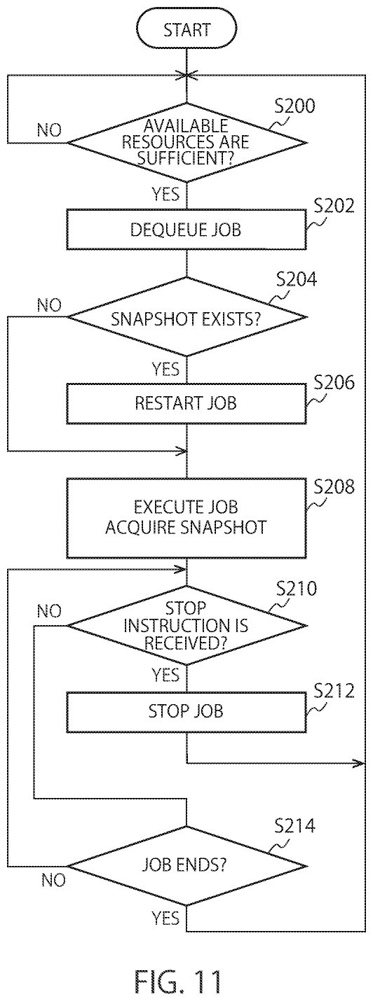

FIG. 11 is a flowchart illustrating a flow of processes of the job execution device 20. In the following explanation, it is assumed that there is a master device as the job execution device 20 and that the master device is executing jobs using each resource. The following explanation is not limited to the case and can be applied to a case where the jobs enqueued in the job queue 106 are generated as a container as a new job execution device 20 at a timing when the resources become sufficiently available. The container may, for example, be generated by a master computer in a cluster where the job execution device 20 is implemented, or by a server, such as a management server, where the scheduling device 10 is implemented.

First, the job execution device 20 determines whether resources necessary to execute a job at the top enqueued in the job queue 106 exist (S200). When the resources are not sufficiently available (S200: NO), the process returns to the standby state. In this case, the process may stand by detecting the availability of the resources, or by checking the state of the resources at predetermined intervals.

When there is sufficient resource availability to execute the job (S200: YES), the job is dequeued (S202). In the case of the container, dequeuing may generate the job execution device 20 that executes the dequeued job.

Next, the job execution device 20 refers to the storage 30 to check whether a snapshot (resume information) corresponding to the job exists (S204). When the snapshot corresponding to the job exists (S204: YES), the arithmetic operation executer 200 restarts the job from the state of the snapshot by referring to the snapshot stored in the storage 30 or by downloading the snapshot, and the like. (S206).

When the snapshot does not exist (S204: NO), the arithmetic operation executer 200 executes the dequeued job from an initial state as a new job. In addition to executing the restarted job or the new job, the SS acquirer 202 acquires a snapshot and stores it to the storage 30 at a predetermined timing (S208). As described above, the time when the acquisition of the snapshot is started is stored. The time notifier 204 transmits the time when the acquisition is started to the scheduling device 10 at the timing when the acquisition is completed.

When a high-priority job is not particularly accepted and a stop instruction is not received (S210: NO), the arithmetic operation executer 200 continues to execute the arithmetic operation. Then, it is determined whether the job ends (S214), and when the job does not end (S214: NO), the process shifts to a standby state for receipt of the stop instruction. In the flowchart, S210 and S214 are described serially but are not limited thereto, and these two determinations may be monitored in parallel in the job execution state.

When the stop instruction is received (S210: YES), the job execution device 20 stops the execution of the job (S212) and moves to a waiting state. When the job is being executed in a container, the container may be erased as appropriate. When the job ends (S214: YES) without receiving a stop instruction (S210: NO), the job is similarly placed in the standby state or the container is erased.

As the job execution device 20, the device that exists as a master may execute jobs from the master device, as described above, or each job execution device 20 may be generated as a container. This implementation can be changed appropriately according to a management state of the computer, duster, and the like, and a method described in this embodiment can be implemented independently of these management methods.

As described above, this embodiment makes it possible to use snapshots to schedule jobs according to their priority. By calculating the cost from the state where the snapshot is acquired, it is possible to perform scheduling that suppresses waste of resources in the cluster as well as the priority. The scheduling device 10, the job execution device 20, and the storage 30 described above may be configured together as a scheduling system. In the case where a nonvolatile memory is used as the storage 30, snapshots are stored even when not in an energized state, making it possible to increase maintainability of the servers that make up the cluster and to eliminate the waste of resources that would have been applied to data that has already been calculated.

By using the time of the snapshot acquisition to calculate the cost, it is possible to perform priority-based scheduling for processes that generally have large calculation costs, including calculation time or resources, such as machine learning and big data usage, for example. Although these processes have a large calculation cost, it is possible to effectively acquire a snapshot at each predetermined timing (for example, every one epoch).

This embodiment can also be applied to the case where live migration is used to restart the suspended job by acquiring a dump of a running process in operation. When executing live migration, a guest OS on a virtual machine is notified in advance of the start of the migration at a predetermined time before the migration is executed. That is, a certain amount of time is required for the live migration to take place. Therefore, at the timing of this advance notification, it is possible to use a method of selecting the job to be stopped in the scheduling device 10 according to this embodiment.

In the scheduling device 10 and the job execution device 20 according to some embodiments, each function may be implemented by a circuit constituted by an analog circuit, a digital circuit, or an analog/digital mixed circuit. A control circuit which controls each function may be included in the optimization apparatus 1. Each circuit may be implemented as an ASIC (application specific integrated circuit), an FPGA (field programmable gate array), or the like.

In all of the foregoing explanations, at least a part of the scheduling device 10 and the job execution device 20 may be constituted by hardware, or by software and a Central Processing Unit (CPU) or the like may implement the function through information processing of the software. When it is constituted by software, programs that enable the scheduling device 10, the job execution device 20 and at least a part of the functions may be stored in storage media, such as a flexible disk and a CD-ROM, and may be executed by being read by a computer. The storage media are not limited to detachable media such as a magnetic disk or an optical disk, and may include fixed storage media such as a hard disk device and a memory. That is, the information processing may be concretely implemented using hardware resources. For example, the processing may be implemented on a circuit such as the FPGA, and may be executed by hardware. The generation of the models and the subsequent processing of the model input may be performed by using, for example, an accelerator such as a Graphics Processing Unit (GPU).

For example, a computer may be programmed to act according to the above embodiments by dedicated software stored in a computer-readable storage medium. The kinds of storage media are not limited. The computer may be used to implement a device according to the embodiment by installing dedicated software on the computer, e.g., by downloading the software through a communication network. The information processing is thereby concretely implemented using hardware resources.

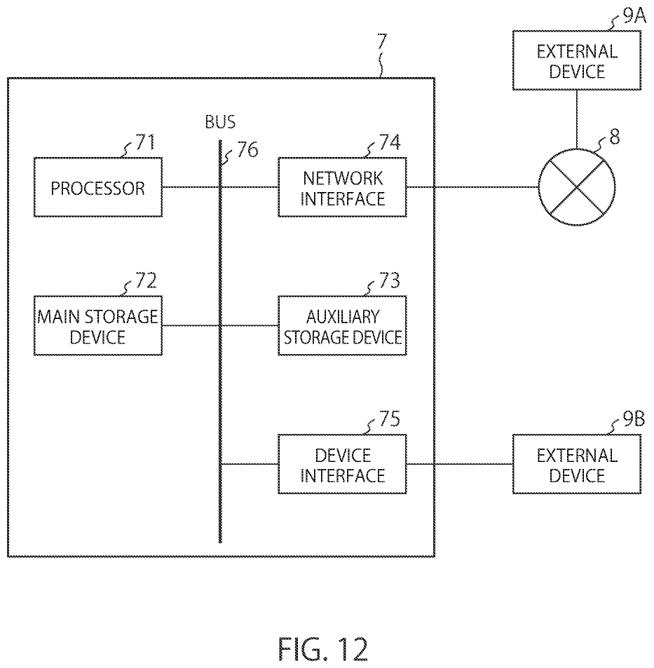

FIG. 12 is a block diagram illustrating an example of a hardware configuration according to some embodiments of the present disclosure. The scheduling device 10 and the job execution device 20 may include a computing device 7 having a processor 71, a main storage 72, an auxiliary storage 73, a network interface 74, and a device interface 75, connected through a bus 76.

Although the computing device 7 shown in FIG. 5 includes one of each component 71-76, a plurality of the same components may be included. Moreover, although one computing device 7 is illustrated in FIG. 5, the software may be installed into a plurality of computing devices, and each of the plurality of computing devices may execute a different part of the software process.

The processor 71 may be an electronic circuit (processing circuit) including a control device and an arithmetic logic unit of the computer. The processor 71 may perform arithmetic processing based on data and programs input from each device or the like of an internal configuration of the computing device 7, and output arithmetic operation results and control signals to each device or the like. For example, the processor 71 may control each component constituting the computing device 7 by executing an OS (operating system), applications, and so on, of the computing device 7. The processor 71 is not limited to a particular processor and may be implemented by any processor capable of performing the above-stated processing.

The main storage 72 may store instructions executed by the processor 71, various data, and so on, and information stored in the main storage 72 may be directly read by the processor 71. The auxiliary storage 73 may be a storage other than the main storage 72. These storages may be implemented using arbitrary electronic components capable of storing electronic information, and each may be a memory or a storage. Both a volatile memory and a nonvolatile memory can be used as the memory. The memory storing various data in the scheduling device 10 and the job execution device 20 may be formed by the main storage 72 or the auxiliary storage 73. For example, at least one of the storages 12 for the scheduling device 10 and the job execution device 20 may be implemented in the main storage 72 or the auxiliary storage 73. As another example, at least a part of the storage 30 or a part of the storer 104 may be implemented by a memory which is provided at the accelerator, when an accelerator is used.

The network interface 74 may be an interface to connect to a communication network 8 through a wire or wireless interface. An interface which is compatible with an existing communication protocol may be used as the network interface 74. The network interface 74 may exchange information with an external device 9A which is in communication with computing device 7 through the communication network 8.

The external device 9A may include, for example, a camera, a motion capture device, an output destination device, an external sensor, an input source device, and so on. The external device 9A may be a device implementing a part of the functionality of the components of the scheduling device 10 and the job execution device 20. The computing device 7 may transmit or receive a part of processing results of the scheduling device 10 and the job execution device 20 through the communication network 8, like a cloud service.

The device interface 75 may be an interface such as a USB (universal serial bus) which directly connects with an external device 9B. The external device 9B may be an external storage medium or a storage device. At least part of the storage may be formed by the external device 9B.

The external device 9B may include an output device. The output device may be, for example, a display device to display images, and/or an audio output device to output sounds, or the like. For example, there external device may include an LCD, (liquid crystal display), a CRT (cathode ray tube), a PDP (plasma display panel), a speaker, and so on. However, the output device is not limited to these examples.

The external device 9B may include an input device. The input device may include devices such as a keyboard, a mouse, a touch panel, or the like, and may supply information input through these devices to the computing device 7. Signals from the input device may be output to the processor 71.

In the present specification, the representation of “at least one of a, b and c” or “at least one of a, b, or c” includes any combination of a, b, c, a-b, a-c, b-c and a-b-c. It also covers combinations with multiple instances of any element such as a-a, a-b-b, a-a-b-b-c-c or the like. It further covers adding other elements beyond a, b and/or c, such as having a-b-c-d.

Furthermore, when performing the live migration, there is no guarantee that the dump will be acquired at the same timing when the program contains host-related information such as IP address or time-dependent operations, and the process may be complicated and difficult to execute. On the other hand, according to this embodiment, even in such cases, it is possible to cope with changes in an execution environment such as hardware by using software level snapshots.

1. A scheduling device comprising:
at least one storage that stores information regarding jobs in execution; and
at least one processor configured to:
accept a job,
select, when an execution resource for the accepted job is not secured, at least one job with a lower priority than the accepted job from the jobs in execution as a stop candidate based on the information regarding the jobs in execution, and
issue a stop instruction to the stop candidate.

2. The scheduling device according to claim 1, wherein
the information regarding the jobs in execution stored in the at least one storage includes information regarding a time when resume information regarding the job in execution is acquired, and
the at least one processor selects the stop candidate based on an elapsed time from the time.

3. The scheduling device according to claim 2, wherein
the information regarding the jobs in execution stored in the at least one storage includes information regarding a cost per unit time of the job in execution, and
the at least one processor selects the stop candidate based on a multiplication value of the elapsed time from the time and the cost per unit time.

4. The scheduling device according to claim 2, wherein
the resume information is a snapshot of the job in execution.

5. The scheduling device according to claim 4, wherein
the snapshot is acquired after one epoch of machine learning is completed.

6. The scheduling device according to claim 1, wherein
after the stop candidate is stopped or the stop instruction is issued, the at least one processor is further configured to set the stop candidate that is stopped in a state waiting for execution.

7. A scheduling system, comprising:
a client that accepts a job;
the scheduling device according to claim 1; and
a job execution device that executes the job according to an order enqueued in a job queue in which the scheduling device enqueues the job.

8. The scheduling system according to claim 7, wherein
the job execution device is implemented by a container.

9. A scheduling method, comprising:
accepting, by at least one processor, a job;
determining, by the at least one processor, whether a resource to execute the accepted job is secured;
selecting, by the at least one processor, at least one job with a lower priority than the accepted job from jobs in execution as a stop candidate based on information regarding the job in execution; and
issuing, by the at least one processor, a stop instruction to the stop candidate.

10. The scheduling method according to claim 9, further comprising:
selecting, by the at least one processor, the stop candidate based on an elapsed time from a time at which resume information regarding the job in execution is acquired.

11. The scheduling method according to claim 10, further comprising:
selecting, by the at least one processor, the stop candidate based on a multiplication value of the elapsed time from the time and a cost per unit time of the job in execution.

12. The scheduling method according to claim 10, wherein
the resume information is a snapshot of the job in execution.

13. The scheduling method according to claim 12, wherein
the snapshot is acquired after one epoch of machine learning is completed.

14. The scheduling method according to claim 9, further comprising:
setting, by the at least one processor, the stop candidate that is stopped, to a state waiting for execution after the stop candidate is stopped or after the stop instruction is issued.

15. The scheduling method according to claim 9, further comprising:
accepting a job at a client;
enqueuing the job in a job queue; and
executing the job according to an order enqueued in the job queue.

16. The scheduling method according to claim 15, wherein
execution of the job according to the order enqueued in the job queue uses a container.

17. A non-transitory computer-readable medium storing a program executing a method comprising:
when executed by at least one processors,
accepting a job;
determining whether a resource to execute the accepted job is secured;
selecting, when the resource to execute the accepted job is not secured, at least one job with a lower priority than the accepted job from the jobs in execution as a stop candidate based on information regarding the job in execution; and
issuing a stop instruction to the stop candidate.

18. The non-transitory computer-readable medium according to claim 17, wherein the method further comprises:
selecting the stop candidate based on an elapsed time from a time at which resume information regarding the job in execution is acquired.

19. The non-transitory computer-readable medium according to claim 17, wherein the method further comprises:
selecting the stop candidate based on a multiplication value of the elapsed time from the time and a cost per unit time of the job in execution.

20. The non-transitory computer-readable medium according to claim 17, wherein
the resume information is a snapshot of the job in execution.
